(19) United States
(12) Patent Application Publication
(10) Pub. No.: US 2005/0195337 A1
(43) Pub. Date: Sep. 8, 2005

(54) Radio vision electronic network/analog output/viewing system

(76) Inventor: Keith Jones (aka Jabari), Chicago, IL (US)

Correspondence Address: Keith Jones aka Jabari, Apt. 2B, 1614 W. Jonquil Terr., Chicago, IL, 60626, US

(21) Appl. No.: 10/823,912

(22) Filed: Apr. 14, 2004

Related U.S. Application Data
(60) Provisional application No. 60/463,103, filed on Apr. 14, 2003.

(51) Int. Cl. H04H 5/00; H04N 5/46; H04N 5/50

(52) U.S. Cl. 348/729; 348/731

(57) ABSTRACT

A System for Broadcasting and listening to the Radio and Viewing slow Scan TV Pictures. Using an ordinary AM/FM Receiver and a Slow Scan Video Converter (SSTV) Why not FSTV or Regular TV Pictures on the AM/FM Band?Well full motion Band Width is 6MC Wide per Channel. A very raw and not to Scale Example would be; if I Extended My arms outward from My left to my right side then from My left hand finger tips to My right hand finger tips would be My TV Bandwidth (FSTV) fast Scan TV. Now lets say on one arm only. From My elbow to My finger tips on the same arm is the Bandwidth for FM, and on that same arm from My wrist to My finger tips would be the AM Bandwidth, and now where My hand ends and my finger tips begin from that point to My finger tips would be the Bandwidth for (SSTV) Slow Scan TV. As you can see full motion TV (NBTV is another Story 431730 per 1982 Brown 483/22), is too wide and would not fit into the AM 10 khz or the FM 200 khz Bandwidth per Channel Further more even Full Motion TV can make use of SSTV; such as the WYMAN AM439 ATV Transmitter in combination with TASCO TSC-70 Slow Scan Color TV Converter. XM and SIRIUS Satellite Radio's CNN and FOX News Channel are Audio only from the Cable Stations to the Satellite Radio Services. For Example CNN could send the SSTV Signal through its SAP to XM and XM then send the SSTV Signal through its RDS Channel. My particular Transmitter is an AM Stereo setup with Slow Scan Video, for Example; My AM Audio Carrier is 700 khz with a Bandwidth of 10 khz (695 khz to 705 khz) and My AM Video Carrier is at 692 khz with a Bandwidth of 4 khz (690 khz to 694 khz). A total of 15 khz wide allowable by the FCC for standard AM broadcast in the United States. The Slow Scan Video can be an AM Picture using Robot 36 Mode of FM Picture in the AM Band using the fast FM Mode of the VC-H1 and a Transmitter like the AM 88 North Country Radio that can broadcast an AM/FM Mode on the AM Band In addition, SSTV Pictures can be had on FM, using the RDS at 57 khz or the SCA at the 67 khz above the main FM carrier. Now because of Modulation differences (if desired) and Frequency difference (−8 khz) there is no interference between the Audio and Video on the AM Service. A Diplexer and an Antenna Tuner enables both Signals to be sent out from the same Antenna.

### US PATENT DOCUMENTS

| | | | |
|---|---|---|---|
| 21141973 | December 1938 | Finch | |
| 4057836 | November 1977 | Munsey | 358/140 |
| 4099202 | July 1978 | Cavanaugh | 358/133 |
| 4688255 | August 1987 | Kahn | 3811/133 |
| 4849811 | July 1989 | Kleinerman | 358/133 |
| 5164980 | November 1982 | Bush | 379/53 |

### BACKGROUND OF THE INVENTION

Using two, double Sideband Full Carrier AM Transmitters, to produce Stereo and one other Transmitter, either AM, NBFM or Single Sideband Suppress Carrier in the AM Band to produce the Slow Scan Video on AM Band 8 khz Down from the main Audio Carrier. With the use of a Diplexer, an Antenna Tuner and an Antenna Stacker Earth grounded, will make for good separation of the AM Station's Audio and Video carriers within a 15 khz Bandwidth.

Single Sideband Suppress Carrier will work well for the Slow Scan Video also but like NBFM, one would need special Receivers for those two Modulations.

Using NBFM transmitter in the AM Band will enable the VC-H1 to use the fast FM mode; the Fax like beeps will be very faint over the AM Receiver if tuned to the Video Frequency.

This system for slow scan Video can be used for FM Radio, using the RDS 57 khz or the SCA 67 khz above the main carrier of the FM channel. This Freeze Frame Video known as SSTV.

FSTV operators could run SSTV over their SAP (second Audio Programmer) of the commercial TV station. Some Amateur TV operators do run Video on the AM Carrier, Audio on the FM-1 Carrier, and SSTV on the FM-2 Carrier. (AM 439 and TSC-70.)

This AM Video System is different from Mr. Khan's AM Audio/Data System because the Data is embedded in the audio.

SSTV will not mix with Audio, that is why there is a Frequency difference in the Raven System, furthermore the FCC does not consider SSTV Picture information as Data.

The Auto Switch LM555 Timing Circuit (Designed and built by this Inventor) enables one to broadcast one to two Pictures per Minute. Right now the IBOC Digital AM System requires a channel Bandwidth of 30 khz and no Video as of yet!!!

### SUMMARY OF THE INVENTION

Present invention enables the Audio and Slow Scan TV Signals to be transmitted over the same 15 khz Wide Channel on the AM Band. Example: 690 khz to 705 khz in which the Video Carrier is at 692 khz @BW of 4 khz (690 khz to 694 khz) and the Audio Carrier is at 700 khz @BW of 10 khz (695 khz to 705 khz). *Please Note 15 khz Bandwidth @ 700 khz can also mean 692.5 khz to 707.5 khz.

For AM Video an AM Analog Radio with an Analog tuner can be directly tuned to 692 khz. An Analog Radio with a Digital tuner, can be tuned to 690 khz for the Video. By listening the Fax like Beeps, before plugging in a slow scan Converter in the Headphone Jack of the AM Receiver being used for the Video. (For FM Video, the same can be done by Using an FM or SSB-SC Receiver for the Band being used), The same Analog Receiver will tune in the Audio at 700 khz.

A walkman style RCA AM FM Stereo Cassette player # RP-1872C was used to check the on Air Frequencies, also used was a Radio Shack DMM 22-174B set for HZ/KHZ and a GW-INSTEK Digital Frequency Counter# GCF-8010H to check frequency.

All Transmitters used are Hobby Broadcast Equipment and are of the name Brand Ramsey and North Country Radio.

Three receivers were used, two for receiving the stereo in the same manner used for receiving the Khan AM Stereo System. Except in the case of the Raven/RVS/RVN, the right channel receiver is tuned right on the frequency due to the Phase Lock Loop of the AM 25 Transmitter, the Left Channel Receiver is tuned slightly off the Left of the frequency.

Now the third AM receiver needs the use of a Slow Scan Converter like the Kenwood VC-H1, such as the one used at the Transmitter site, the only difference being the VC-H1 at the Transmitter Site is in the Auto Transmit mode (once every 3 minutes), which is too slow for commercial broadcast use. A 555 Timing Circuit was built to cause the auto mode to transmit a new Picture every minute, and with * Live Action Capture* Built in by Kenwood, there is no need to stop the action or pose to send a new Picture. Furthermore, the VC-H1 at the transmitter site will not receive when it is in the Auto Transmitter Mode, therefore will be no video interference from other Radio Stations using the same system.

### BRIEF DESCRIPTION OF THE DRAWINGS AND THE PREFERRED EMBODIMENTS

FIG. 1 Block Diagram of the RAVEN/RVS/RVN SYSTEM

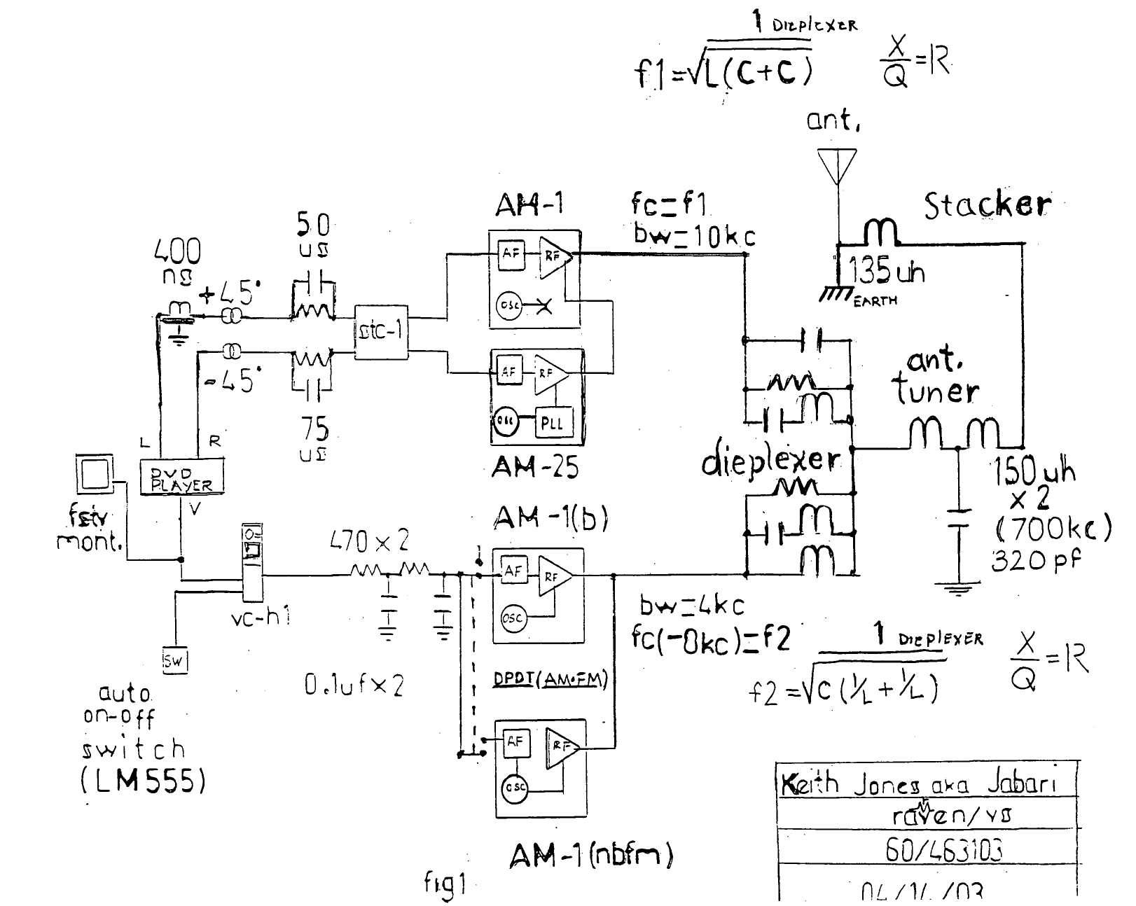

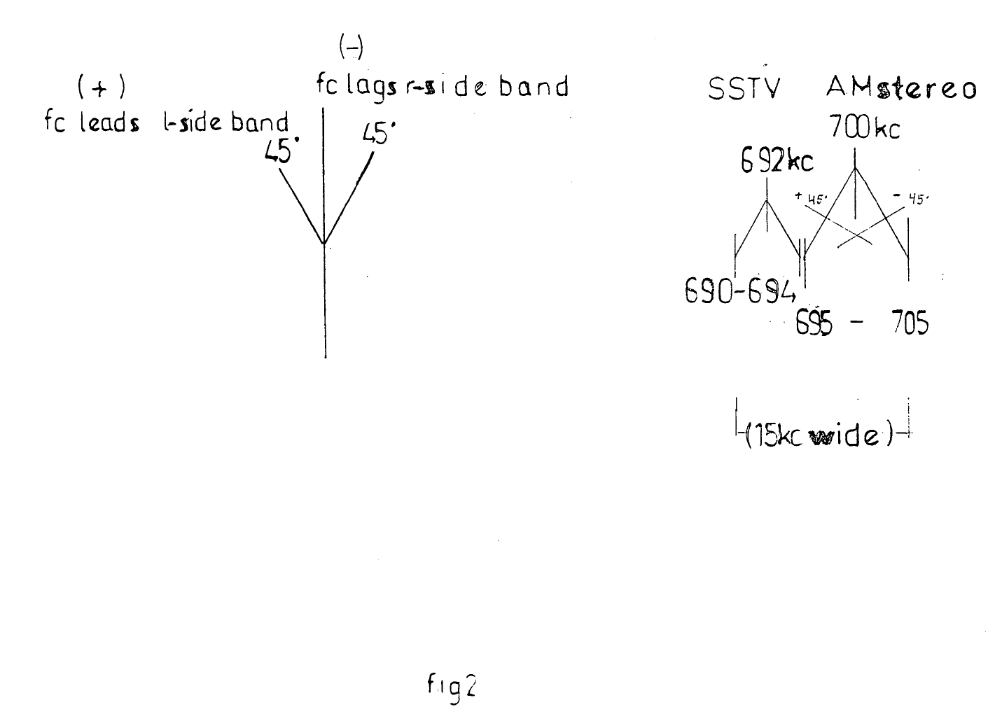

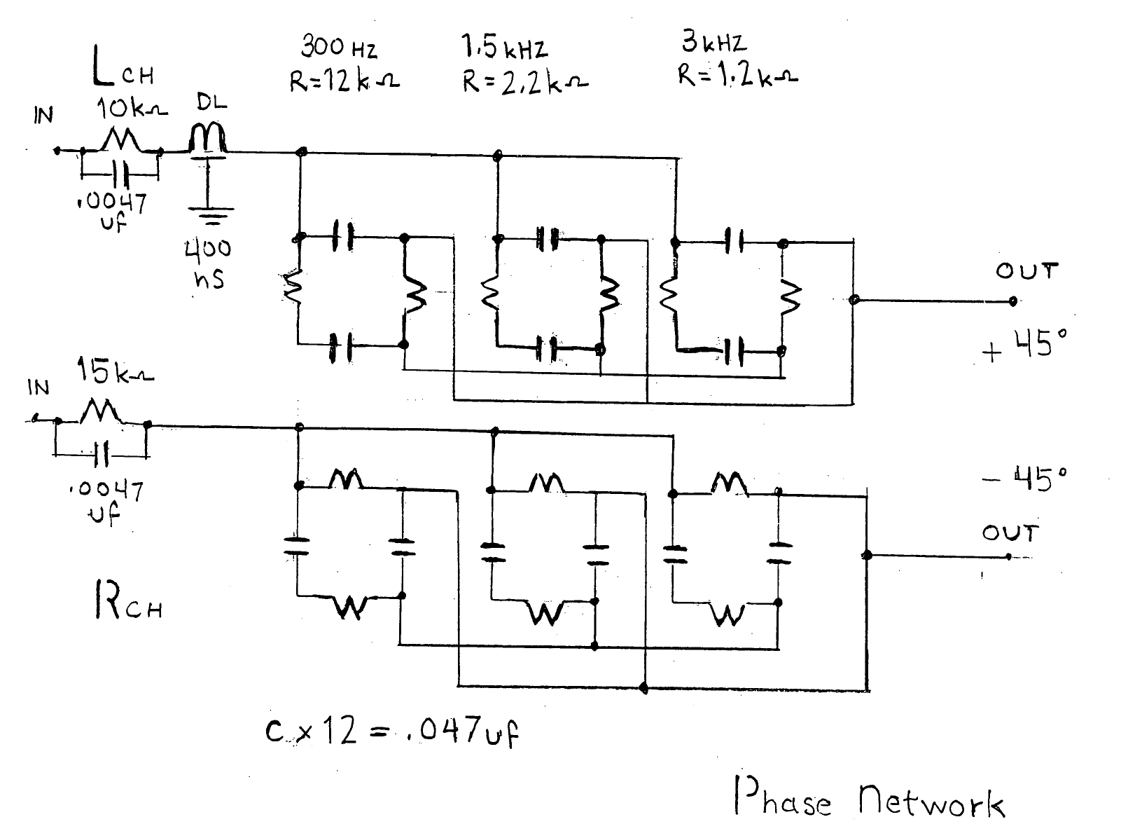

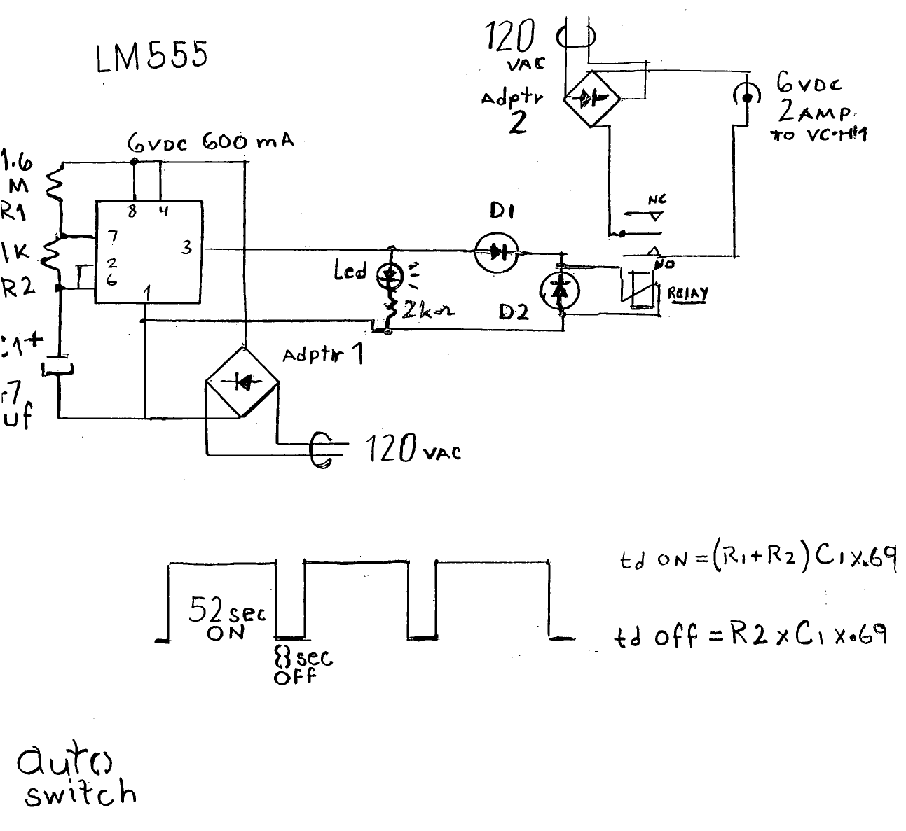

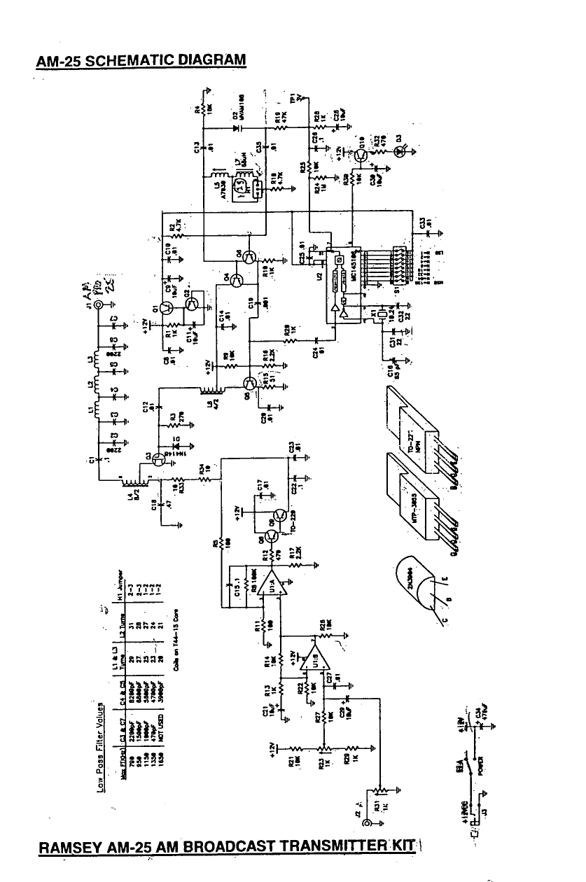

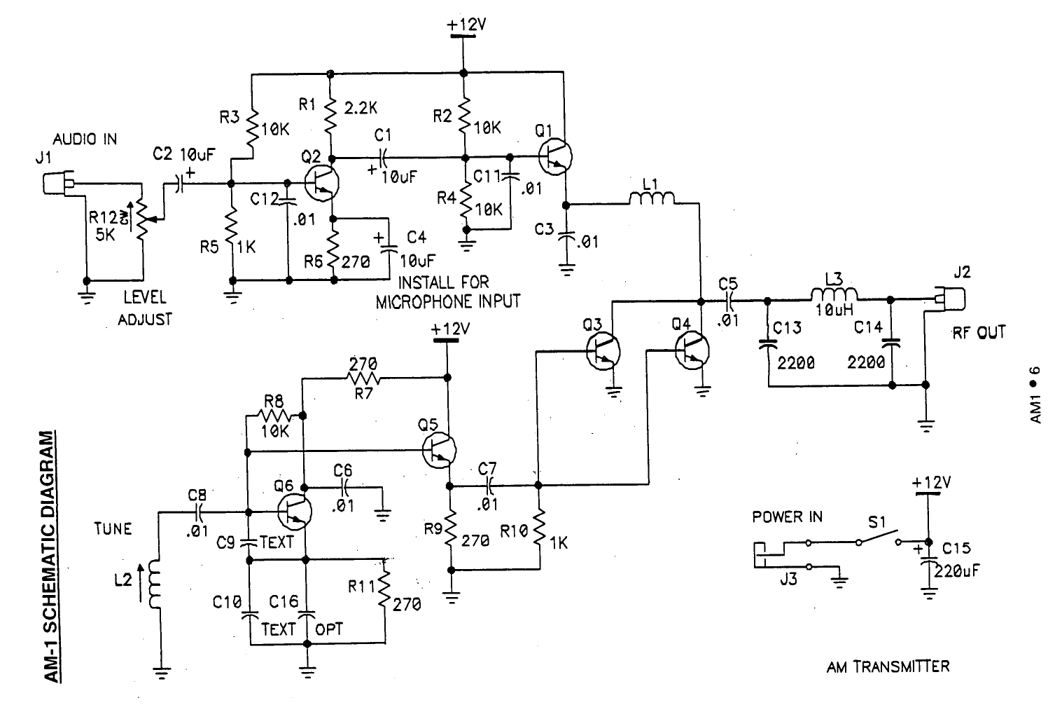

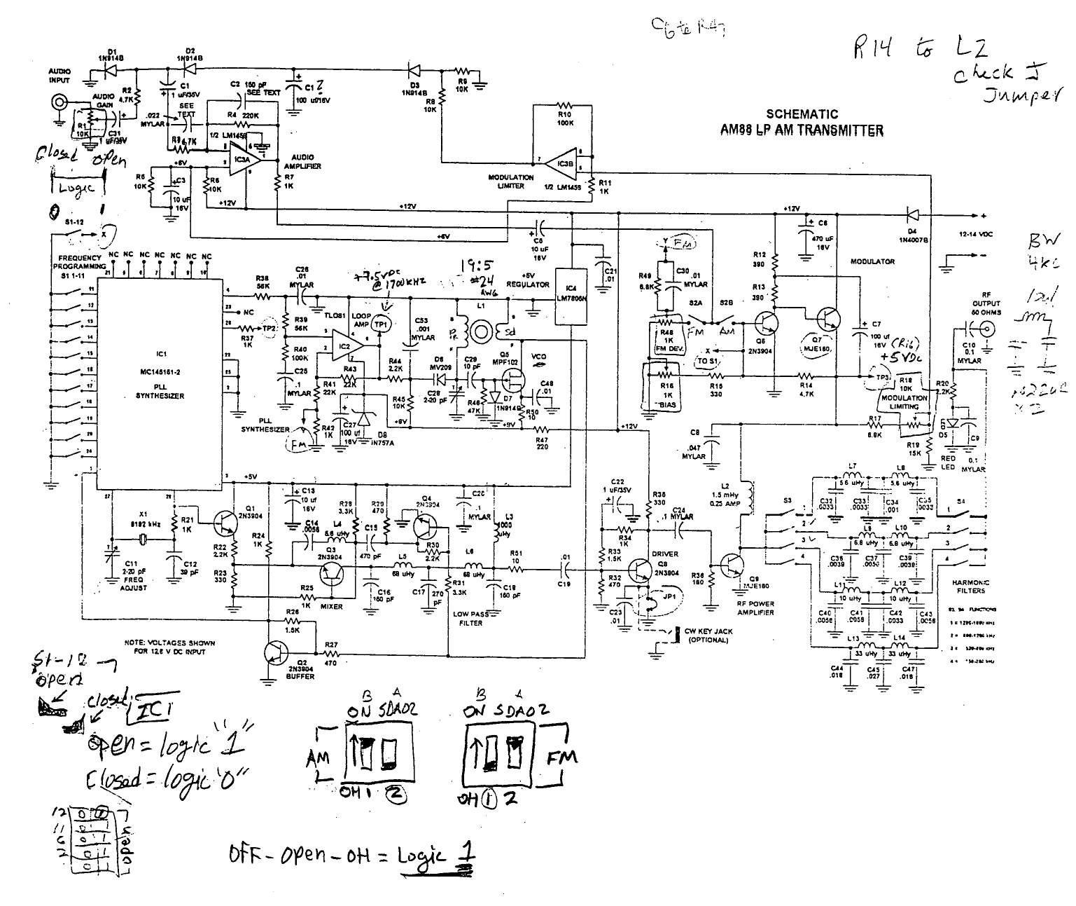

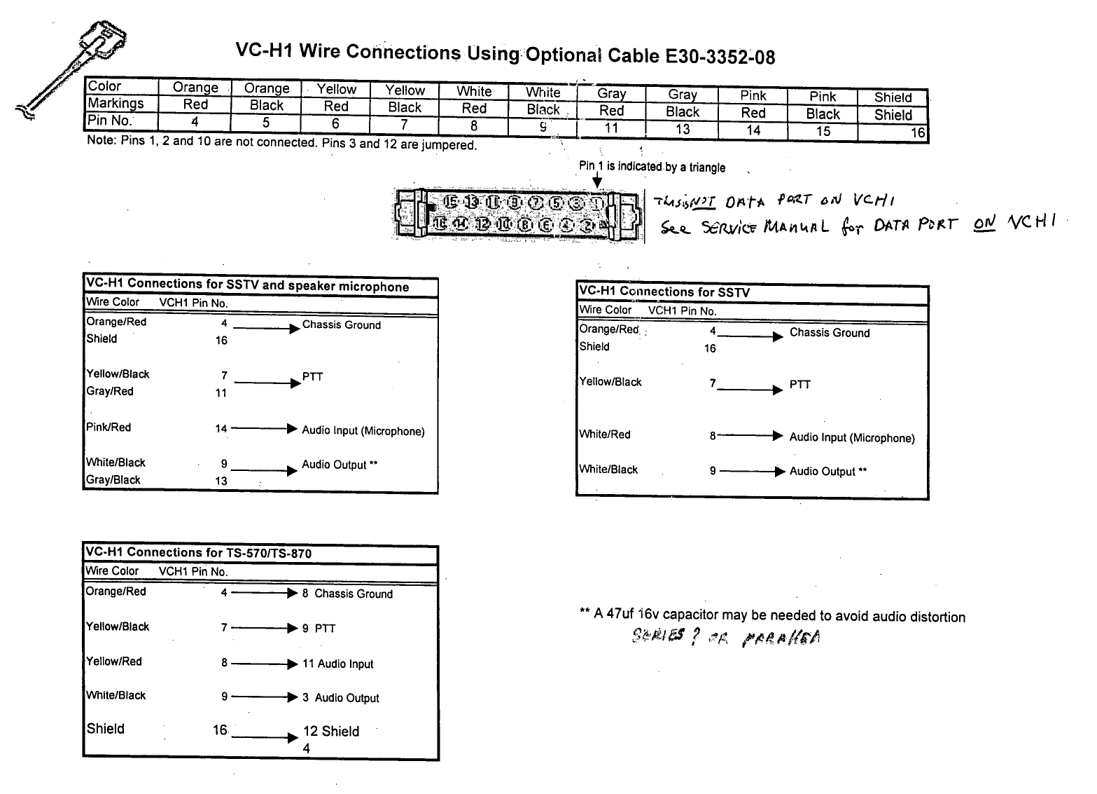

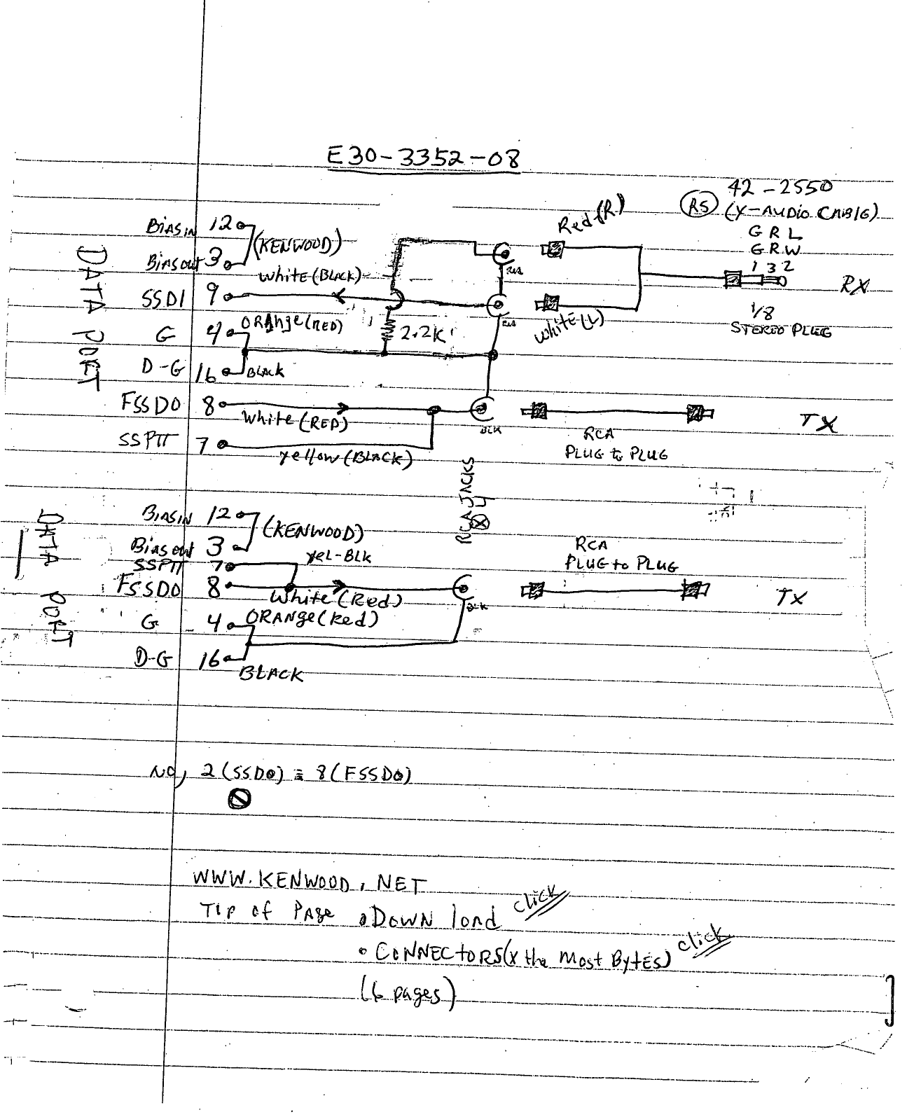

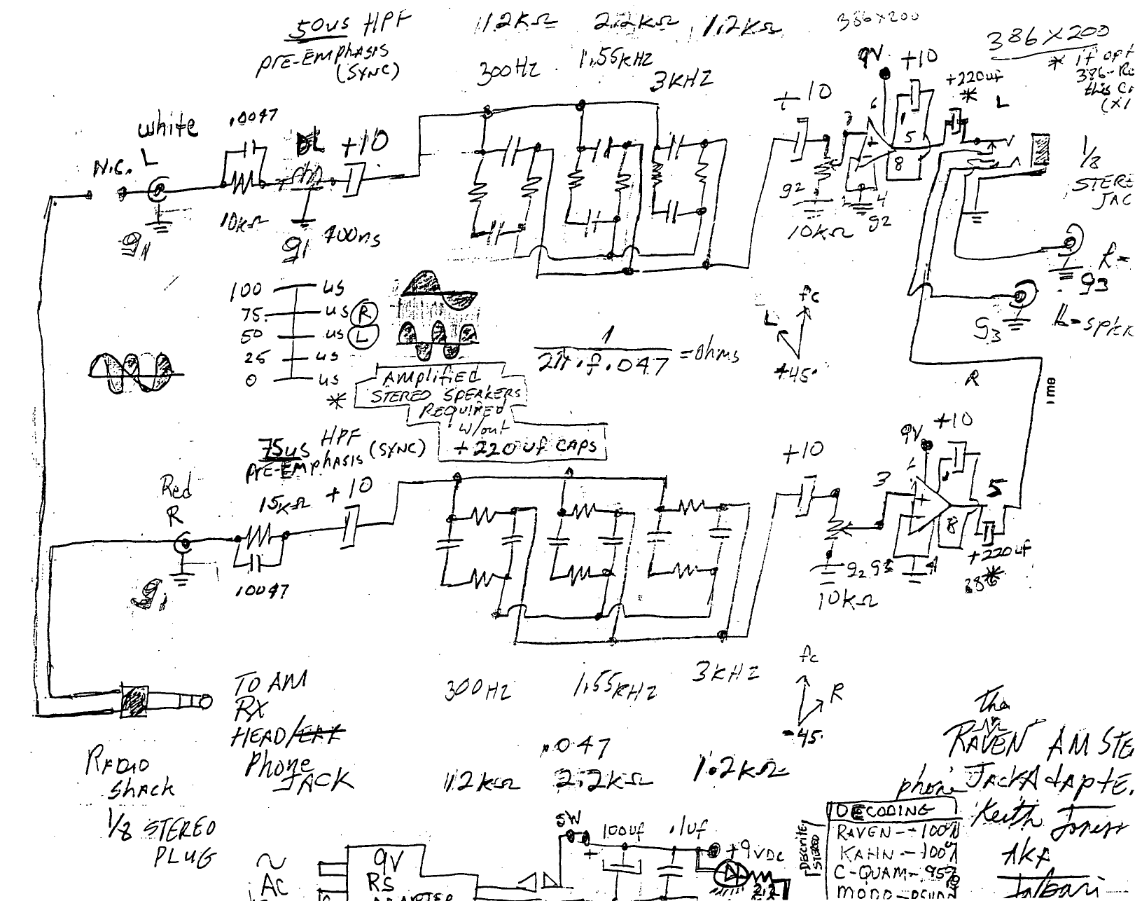

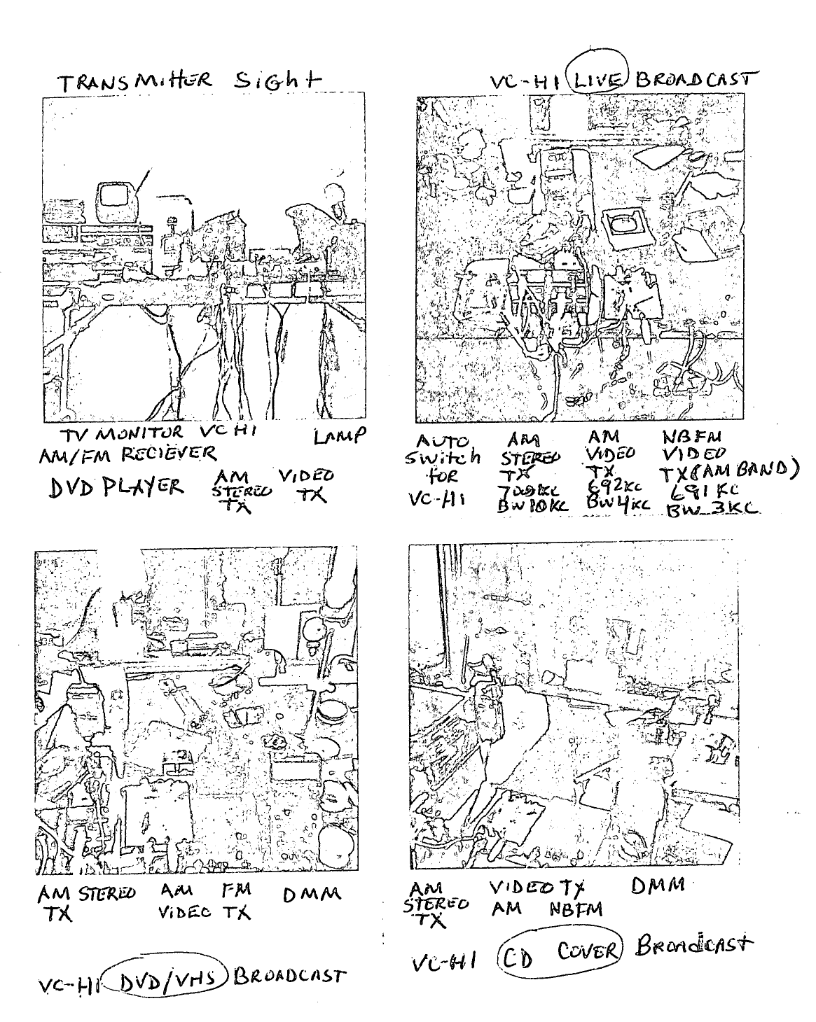

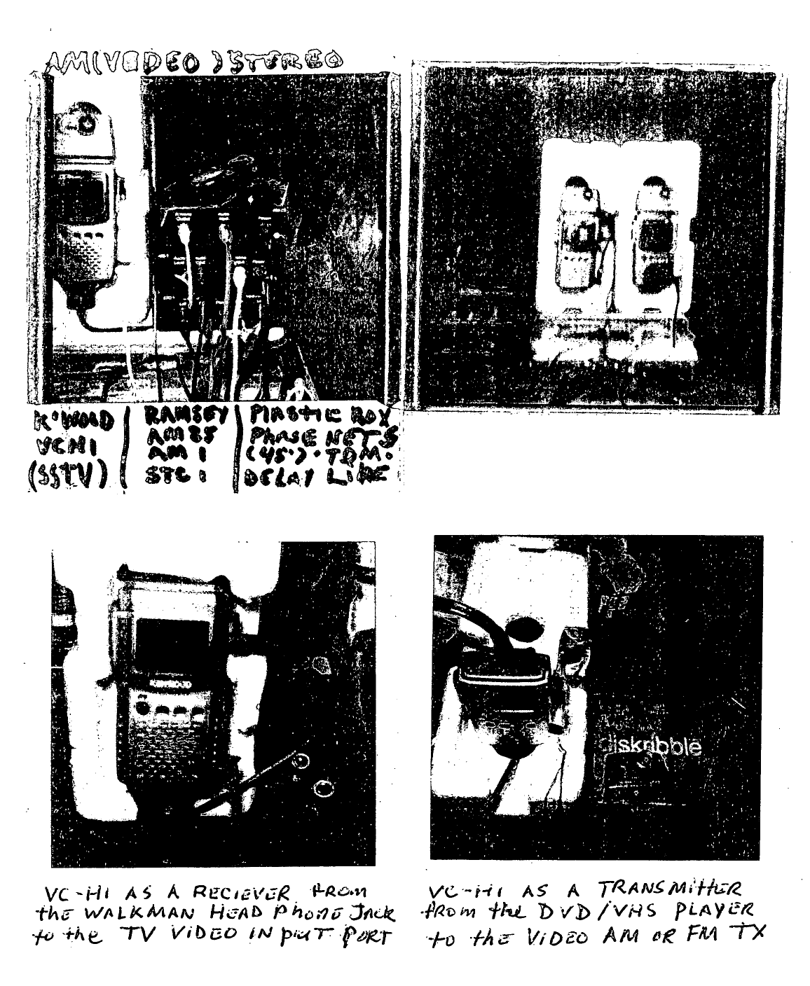

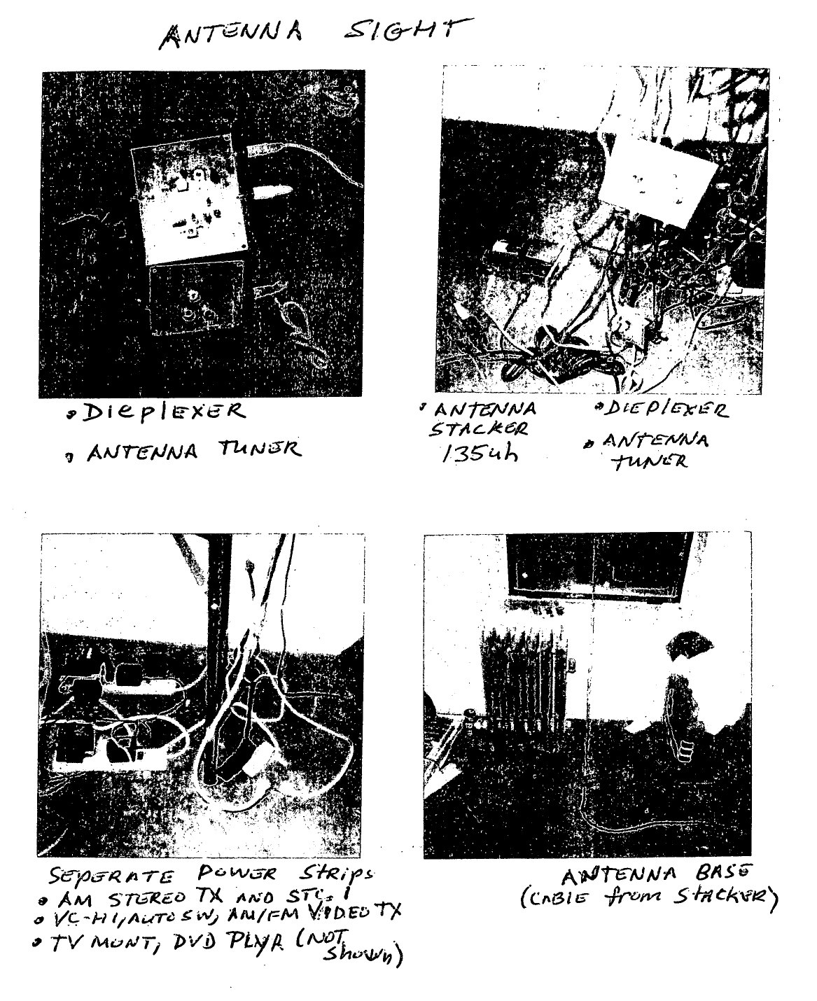

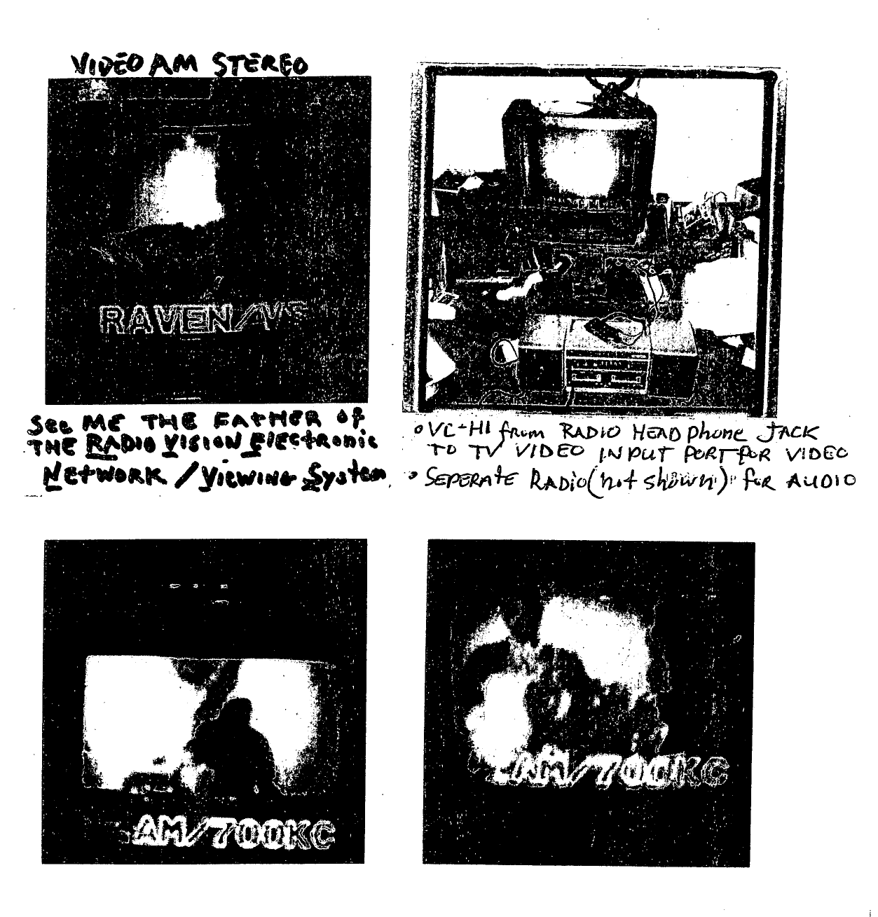

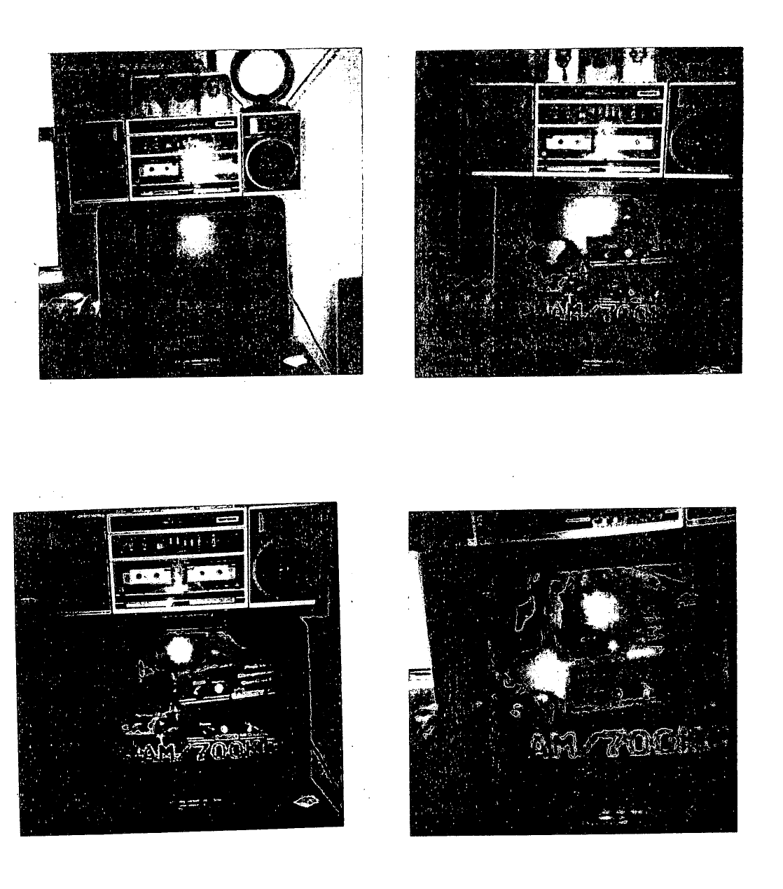

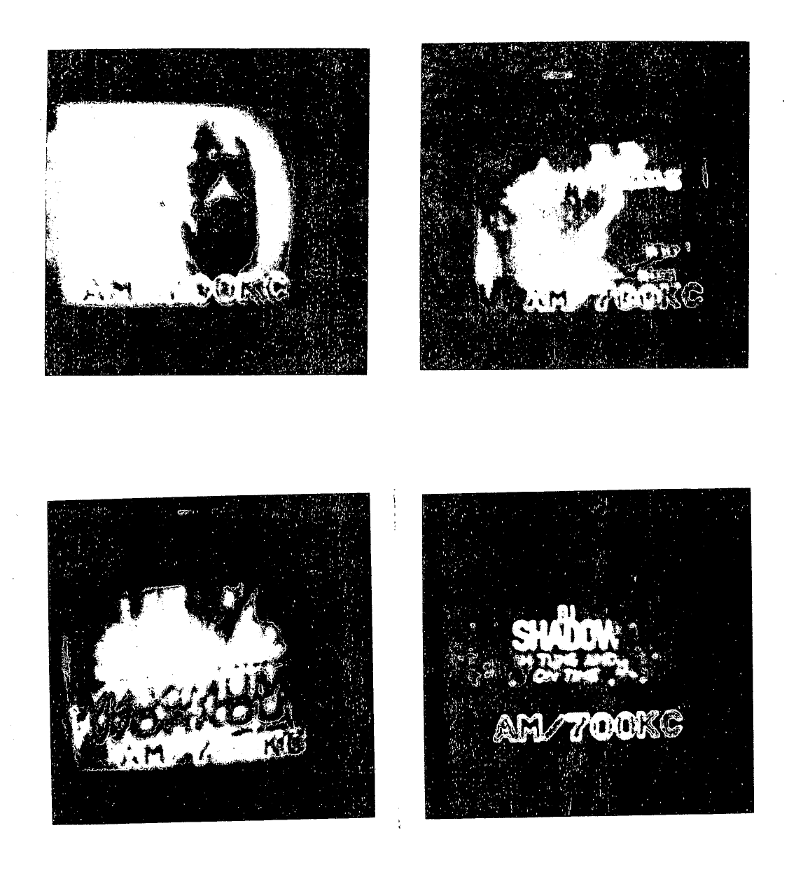

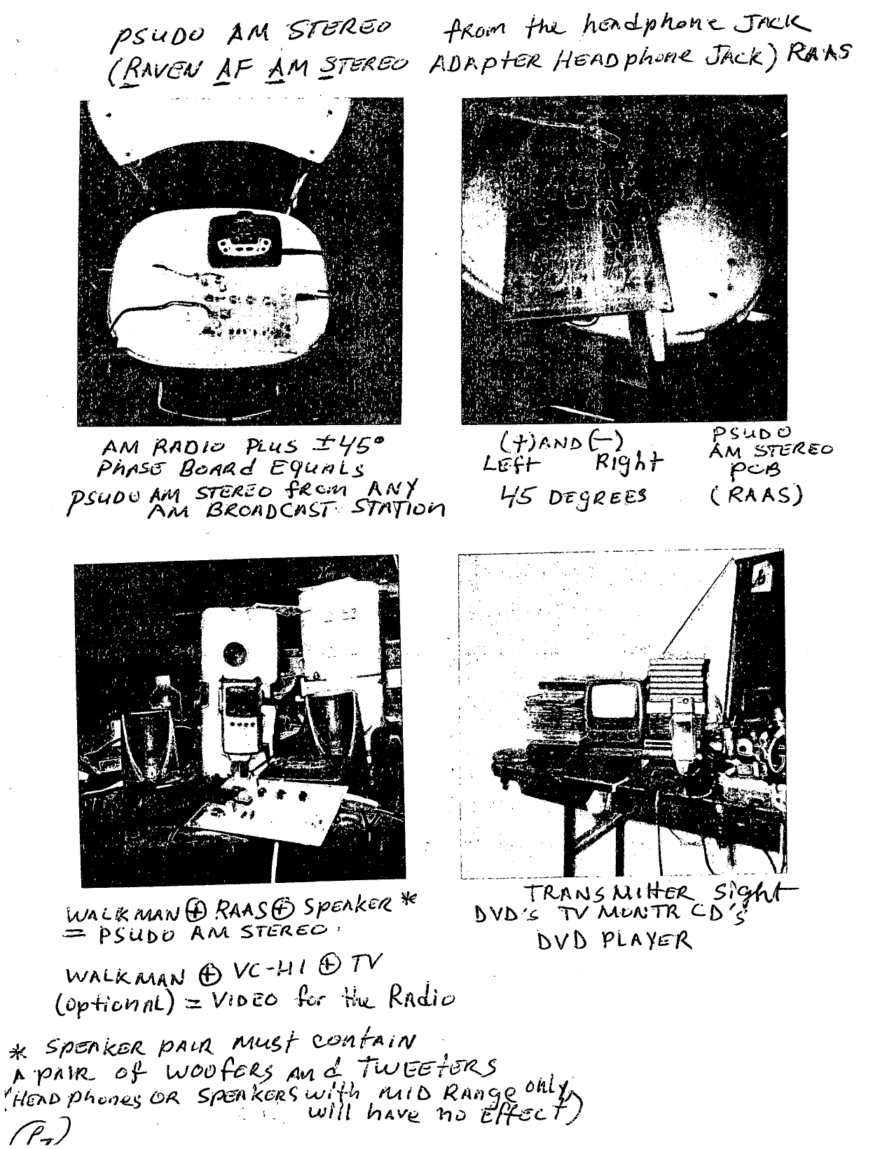

Other Drawings are Schematics of: Ramsey STC-1; Ramsey AM 25 Transmitter; Ramsey AM 1 Transmitter North Country Radio AM 88 Transmitter; Schematics of −45 Degrees +45 Degrees Right and Left Channel Phase Networks.; Kenwood VC-H1 cable setups (two sheets) also LM 555 Auto switch. One Notarized log of three hand drawings on one sheet, the testing of AM Audio on the AM Band, first test of FM Picture FM Band, second test of AM Picture AM Band and finally FM Picture AM Band. (All tests were AM Audio on AM Band)

One, VHS Tape of on Air Operations of the RAVEN/RVS/RVN.

Four pages, of colored Pictures, of RAVEN/RVS/RVN in action.

After the Ramsey STC-1 Stereo Limiter a Ramsey AM one Transmitter with a disabled Oscillator (C7, Q6, and Q5 have been removed).

The Ramsey AM PRO-25 Transmitter with its ANT. out, going into the RF of the AM-1 Transmitter Via R10.

Also the AM PRO-25. Another Q9 was add 9 Collector, Base-to-Base, and Emitter-to-Emitter) in parallel with the original Q9, both with cooling fins.

Changed R23 variable resistor from 1KOHM to 10 KOHM and changed R5 from 1KOHM fixed Resistor to a 10 KOHM variable Resistor and lastly added a 12 Volt Cooling fan from an old computer for extra strong cooling; now the top cover no longer fits the AM PRO 25. A Kenwood VC-H1 inputs into a De-Emphasis Network, that inputs into an AM 1, whose filter network L3 is unchanged but C12 and C14 Values have been changed from 0.0022 UF to 0.02 UF, to obtain the Band width of 4 khz and that output is then Coupled to the Main Antenna Along with the output of the Stereo Signal from the AM 1-AM 25 Transmitter. Both the audio and the video Transmitter system use the same antenna with no loss of power due to the antenna Tuner and Diplexer.

AM 88 Transmitter can be used for FM Pictures in the AM Band, therefore there is no need to modify an AM 1 for that Purpose.

Recommended Power Levels for AM STEREO
And Minute-by-Minute Still Life Pictures

| | |
|---|---|
| AUDIO | VIDEO |

For Commercial Broadcast U.S. AM Radio Stations

| | |
|---|---|
| 50 kw | 5 kw |
| 25 kw | |
| 10 kw | |
| 5 kw | |
| 2.5 kw | 1 kw |
| 1 kw | |
| 500 w | |
| 250 w | 100 w |
| 100 w | |

Low Power AM Part - 73

| | |
|---|---|
| 99 w | |
| 50 w | |
| 35 w | 10 w |
| 25 w | |
| 10 w | |
| 5 w | |
| 2 w | |

Hobby Broadcast AM Part - 15

| | |
|---|---|
| 1 w | |
| .75 w | 1 w |
| .25 w | |

The Video Power Recommendations are for AM Pictures. Antenna height should be considered for FM Pictures, such as, if the Antenna height is 1160 Feet then the maximum Video power would be any where from 3 kw to 6 kw, for Commercial Broadcasting.

### OTHER REFERENCES

Magazine article by Harry Maynard: AM STEREO ITS STEREO ITS TIME HAS COME; October 1976 Magazine: NUTS & VOLTS article: Just The Fax by Michael Banks

McGraw-Hill Books: Electronic Communications: PP. 63 and 92; Louis E. Frenzel Third Edition.

Tab Books: The Complete Handbook of Slow Scan-TV by Dave Ingram

Radio Shack 2002 Catalog: A Brief Description of RDS (FM Radio Data Service)

Internet: Slow Scan-TV History 1970 W7FEN: Single Sideband-Suppress Carrier; Lower Sideband Audio; Upper Sideband Video.

Internet: Commercial AM Transmitters; Articles on Power Side and Cam D. Kahn Communications (No Schematics)

Internet: Advertisement; Low Power AM Part-73; AM-30P, AM-60P and AM-100P LPB, Inc.

Hobby Broadcast AM Part 15: AM-1 and AM PRO-25, Schematic Study and Kit Building Ramsey Electronics.

1. To be able to enjoy AM or FM Stereo and Still Life Pictures (A New picture every minute) using ordinary AM/FM receiving equipment (KENWOOD VC−H1 Slow Scan Converter can produce AM OR FM picture with any AM/FM receiver.)

4. Music Radio Stations will be able to run full motion music DVD'S instead of just CD'S. The slow Scan Converter will convert the video to a 3 khz Audio Tone for Broadcast over the commercial AM of FM Band. (Robot 36 for AM Picture or fast FM for FM Pictures.) The AM Video is 8 khz down from the main Radio Carrier. The FM Video can be 57 khz (RDS) or 67 khz (SCA) above the main FM Carrier.

6. Satellite Radio XM and SIRIUS News Stations such as CNN and FOX News Channel are really Audio Feeds from the Cable TV Stations to the Radio Satellite Stations, which makes for awkward listening such as being told, to look at the Weather Map or told to notice the suspect standing by the car.
Instead, Commercial and Cable Television Stations can run SSTV over their SAP for rebroadcast over AM/FM or Satellite Radio Station to Receivers using SSTV Conversions:
